(19) United States
(12) Patent Application Publication
(10) Pub. No.: US 2009/0019175 A1
(43) Pub. Date: Jan. 15, 2009

(54) WIRELESS MULTIMEDIA SYSTEM

(75) Inventor: Hooman HONARY, Newport Beach, CA (US)

Correspondence Address: MCDERMOTT WILL & EMERY LLP, 18191 VON KARMAN AVE., SUITE 500, IRVINE, CA, 92612-7108, US

(73) Assignee: WiGadge, Inc., Newport Coast, CA (US)

(21) Appl. No.: 12/172,177

(22) Filed: Jul. 11, 2008

Related U.S. Application Data
(63) Continuation-in-part of application No. 12/171,247, filed on Jul. 10, 2008.
(60) Provisional application No. 60/958,861, filed on Jul. 10, 2007.

(51) Int. Cl. G06F 15/16

(52) U.S. Cl. 709/231

(57) ABSTRACT

A multimedia system includes one or more media terminals and a media hub. The media hub is configured to be detachably coupled with a media storage device and to be wirelessly coupled with the one or more media terminals. The media hub is further configured to wirelessly stream one or more media files stored on the media storage device independently to the one or more media terminals in response to a request received from each of the one or more media terminals.

This application is a continuation-in-part of U.S. application Ser. No. 12/171,247, filed on Jul. 10, 2008, which claims the benefit of U.S. Provisional Application No. 60/958,861, filed Jul. 10, 2007, both of which are hereby incorporated by reference.

### FIELD

The present invention relates to multimedia systems and, in particular, concerns a wireless multimedia system with multi-stream capabilities.

### BACKGROUND

The digitization of media content, such as music and movies, has dramatically changed the way content is distributed and used. Digital media content can be transferred and stored on a number of different types of devices, such as computers and personal media players. The data storage capacity of these devices is quickly increasing, thereby allowing entire libraries of media content to be stored on a single device. This centralization of media libraries within a single device allows a user to easily transport and access the media contents of the library at different locations.

Centralization of media libraries within a single device also presents some limitations to accessing the media contents. For example, personal media players typically provide a single access point to the media contents stored thereon. Therefore, only one user at a time can access the media library. This limitation may cause problems in a household where multiple users want to access different content within a centrally stored media library. Accordingly, a need exists for improving the accessibility of digital media content.

### SUMMARY

The invention addresses the foregoing needs by providing a wireless multimedia system that provides one or more users with independent access to a centrally stored media library. Using a terminal device, a user is able to request stored media files which are subsequently streamed to the terminal device for playback. Using a pull-type delivery system with multi-stream capabilities, the invention greatly improves access to centrally stored media libraries.

According to one embodiment, a media hub is provided that includes a device interface configured to detachably couple the media hub with a media storage device. The media hub further includes a wireless interface configured to wirelessly couple the media hub with up to a plurality of media terminals. A processing unit is configured to stream one or more media files stored on the media storage device independently to one or more media terminals via the wireless interface in response to a request received from each of the one or more media terminals via the wireless interface.

According to another embodiment, a multimedia system is provided that includes one or more media terminals and a media hub. The media hub is configured to be detachably coupled with a media storage device and to be wirelessly coupled with the one or more media terminals. The media hub is further configured to wirelessly stream one or more media files stored on the media storage device independently to the one or more media terminals in response to a request received from each of the one or more media terminals.

According to another embodiment, a method for providing access to media files stored on a media storage device includes receiving a request at a media hub coupled to the media storage device from each of one or more media terminals for one or more media files stored on the media storage device. The one or more media files are streamed independently from the media hub to the one or more requesting media terminals. The request from each of the one or more media terminals is received wirelessly at the media hub and the one or more media files are streamed wirelessly from the media hub to the one or more media terminals.

According to another embodiment, a machine-readable medium containing machine-executable code for performing a method for providing access to media files stored on a media storage device is provided. The method device includes receiving a request at a media hub coupled to the media storage device from each of one or more media terminals for one or more media files stored on the media storage device. The one or more media files are streamed independently from the media hub to the one or more requesting media terminals. The request from each of the one or more media terminals is received wirelessly at the media hub and the one or more media files are streamed wirelessly from the media hub to the one or more media terminals.

The foregoing summary of the invention has been provided so that the nature of the invention can be understood quickly. A more detailed and complete understanding of the preferred embodiments of the invention can be obtained by reference to the following description of the invention together with the associated drawings.

### BRIEF DESCRIPTION OF THE DRAWINGS

FIG. 1 is a block diagram depicting components of a wireless multimedia system according to one embodiment of the invention.

FIG. 2 is a block diagram depicting components for a media hub according to one embodiment of the invention.

FIG. 3 is a block diagram depicting components of a media terminal according to one embodiment of the invention.

FIG. 4 is a flowchart of steps of method for accessing media files according to one embodiment of the invention.

### DETAILED DESCRIPTION

The detailed description set forth below in connection with the associated drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without all of the specific details contained herein. In some instances, well known structures and components are described in general and may be shown in block diagram form in order to avoid obscuring the concepts of the invention.

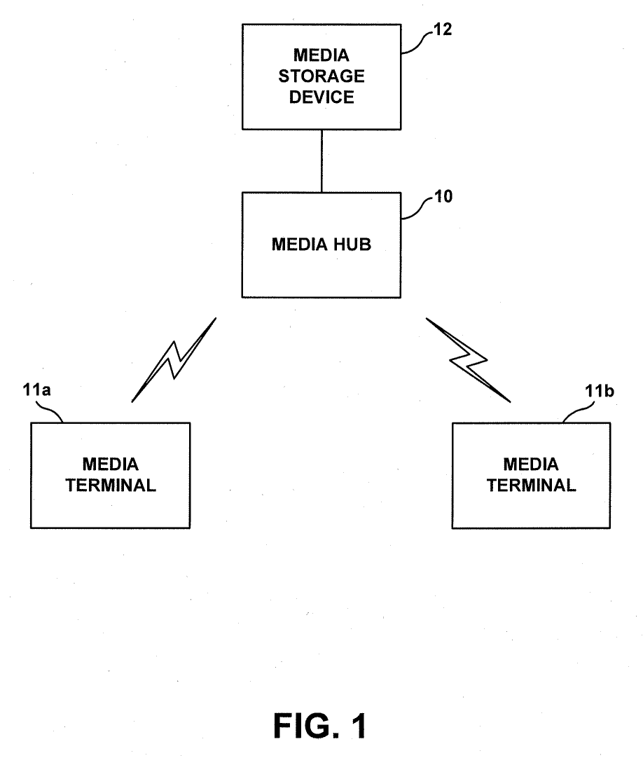

FIG. 1 is a block diagram depicting components of a wireless multimedia system according to one embodiment. The wireless multimedia system depicted in FIG. 1 includes media hub 10 and media terminals 11a and 11b. As shown in FIG. 1, media hub 10 is detachably coupled to media storage device 12 and is wirelessly coupled to media terminals 11a and 11b. In this manner, media hub 10 provides media terminals 11a and 11b with access to media files stored on media storage device 12. A more detailed explanation of each of these components and their operation is provided below.

While FIG. 1 depicts a single media storage device (12) and two media terminals (11a and 11b), one skilled in the art will recognize that the scope of the invention is not limited to this arrangement. For example, media hub 10 may be coupled to more or less than two media terminals 11. Similarly, media hub 10 may be coupled to more than one media storage device 12. Different configurations within the scope of the invention will become apparent to those skilled in the art after reading the description contained herein.

Media storage device 12 represents any device configured to store digital media content such as audio and/or video data in one or more media files, including but not limited to personal computers, personal media players, flash drives, hard drives, etc. The storage media on which the files are stored may include magnetic storage media (hard disk, floppy disk, magnetic tape, etc.), optical storage media (CD, DVD, etc.), and/or electronic/semiconductor storage media (DRAM, ROM, flash memory, EEPROM, etc.). The media files may be stored on media storage device 12 in any known digital format. For example, the media content may be coded using one of the Moving Picture Experts Group (MPEG) standards, Windows Media Audio (WMA), Advanced Audio Coding (AAC), etc.

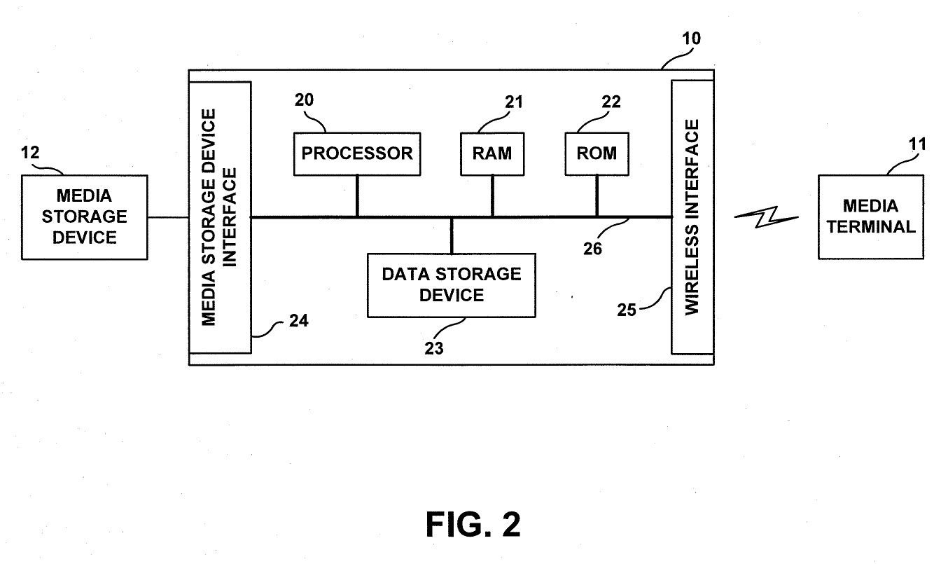

Turning to FIG. 2, media hub 10 will now be described in more detail. FIG. 2 is a block diagram depicting components of media hub 10. The components of media hub 10 include processor 20, random access memory (RAM) 21, read only memory (ROM) 22, data storage device 23, media storage device interface 24 and wireless interface 25. The components of media hub 10 are interconnected and communicate data and commands with each other using bus 26.

Processor 20 represents a microprocessor configured to read and execute sequences of instructions stored as code on a machine/computer readable medium. RAM 21 represents a volatile memory used by processor 20 to temporarily store data and instructions while executing instruction sequences used to perform the operations of media hub 10 described herein. ROM 22 is a non-volatile memory configured to store invariant instructions such as those executed by processor 20 at start-up to begin operation of media hub 10. Data storage device 23 is a non-volatile storage device configured to store data and software modules comprising instruction sequences to be read and executed by processor 20. The software modules include an operating system for managing the overall operation and system resources of media hub 10, drivers for communicating with and controlling components such as media storage device interface 24 and wireless interface 25, and applications used to implement the operations of media hub 10 described in detail below. Data storage device 23 may be implemented using magnetic storage media (hard disk, floppy disk, magnetic tape, etc.), optical storage media (CD, DVD, etc.), and/or electronic/semiconductor storage media (DRAM, ROM, flash memory, EEPROM, etc.). RAM 21, ROM 22 and data storage device 23 all constitute examples of machine/computer readable media.

Processor 20, together with one or more of RAM 21, ROM 22 and data storage device 23, comprises a processing unit within media hub 10. Each of these components may be implemented using discrete logic components. Alternatively, one or more of the components may be integrated into an ASIC or implemented using programmable logic such as an FPGA.

Media storage device interface 24 facilitates the communication of data and commands between media hub 10 and media storage device 12. Media storage device interface 24 may be configured to support a known interface standard or a proprietary interface protocol. For example, media storage device 24 may support Universal Serial Bus (USB), external Serial Advanced Technology Attachment (eSATA), IEEE 1394, etc. Media storage device interface 24 also may be configured to support a networking interface such as Ethernet or a wireless interface such as Bluetooth or IrDA. The operation and functionality of each of these interface standards are known to those of skill in the art and therefore are not described in this disclosure.

In addition to facilitating the communication of data and commands between media hub 10 and media storage device 12, media storage device interface 24 is configured to allow media storage device 12 to be detachably coupled to media hub 10. In this manner, media hub 10 may be treated as a docking station allowing a user to temporarily attach a portable media storage device 12 to media hub 10 in order to take advantage of the functionality provided by media hub 10. This arrangement also allows multiple users each with different media storage devices 12 to access the functionality of media hub 10.

Wireless interface 25 facilitates the communication of data and commands between media hub 10 and one or more media terminals 11. Wireless interface 25 may be configured to support a known wireless interface standard or a proprietary interface protocol. For example, wireless interface 25 may be configured to support one of the 802.11 protocols, Bluetooth or IrDA. The operation and functionality of each of these interface standards are known to those of skill in the art and therefore have not been described in this disclosure.

As noted above, bus 26 is used to interconnect and facilitate communication between the components of media hub 10. Bus 26 comprises one or more signal paths over which data and command signals are communicated between the components. Bus 26 may comprise a single bus or multiple buses. Those skilled in the art will recognize the various configurations that may be used to implement bus 26 within media hub 10.

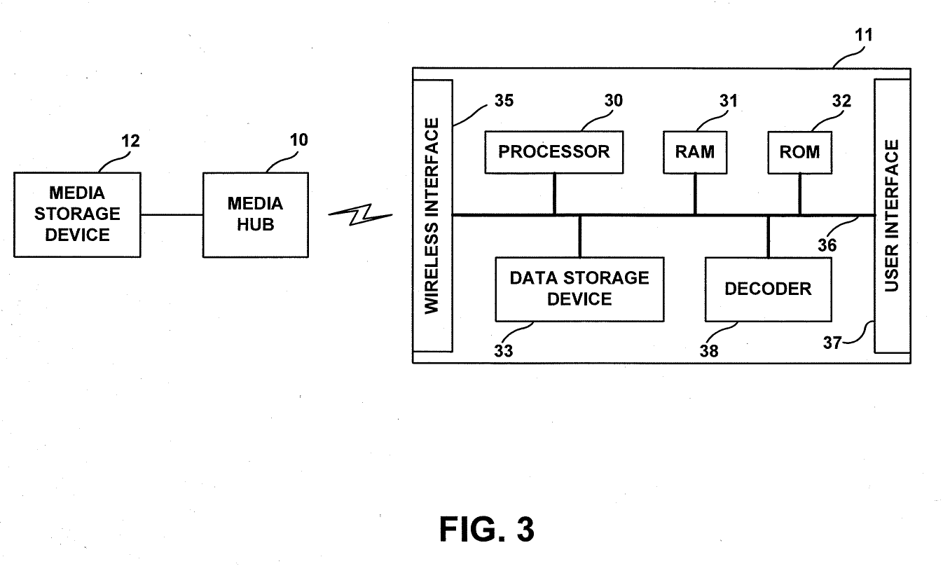

FIG. 3 is a block diagram depicting components of media terminal 11 according to one embodiment. The components of media terminal 11 include processor 30, RAM 31, ROM 32, data storage device 33, wireless interface 35, user interface 37 and decoder 38. The components of media terminal 11 are interconnected and communicate data and commands with each other using bus 36.

Processor 30, RAM 31, ROM 32, data storage device 33 and bus 36 correspond to processor 20, RAM 21, ROM 22, data storage device 23 and bus 26 of media hub 10. Similarly, wireless interface 35 corresponds with wireless interface 25 of media hub 10. Accordingly, reference is made to the description above for examples and the general operation of these components. Similar to data storage device 23, data storage device 33 is configured to store data and software modules comprising instruction sequences to be read and executed by processor 30. The software modules include an operating system for managing the overall operation and system resources of media terminal 11, drivers for communicating with and controlling components such as wireless interface 35 and user interface 37, and applications used to implement the operations of media terminal 11 described herein.

User interface 37 represents one or more components which enables a user to interact with the wireless multimedia system. User interface 37 may include one or more visual elements for displaying information to the user. Additionally, user interface 37 may include a pointer device and/or one or more buttons/keys for selecting options and entering commands. According to one embodiment, user interface 37 may include a remote control device that communicates user input to media terminal 11 via a wired or wireless connection.

In addition to user input components, user interface 37 includes audio and/or video playback components. These components may include a display for displaying video media files and one or more amplified speakers for playing audio media files. Alternatively, user interface 37 may include audio/video interfaces configured to communicate audio signals to an external amplifier and/or video signals to an external video display. In this manner, media files received from media storage device 12 via media hub 10 can be played back to the user. Any decoding of the media file necessary to place the data in a usable format is performed by decoder 38. Decoder 38 represents hardware and/or software used to decode the media file from a coded format such as those mentioned above to a format compatible with the audio/video playback components.

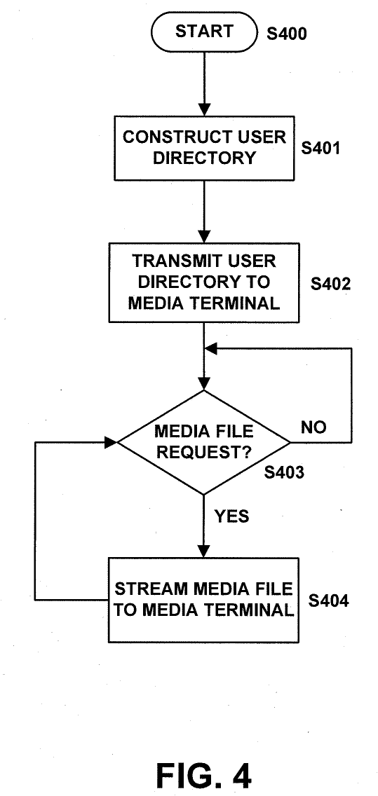

FIG. 4 is a flowchart depicting the steps of a process for accessing media files stored on media storage device 12 according to one embodiment. The process is implemented by the execution of one or more sequences of instructions by the processing units in media hub 10 and media terminal 11. Briefly, a user directory is constructed at media hub 10 in step S401 and transmitted to one or more media terminals 11 in step S402. Media hub 10 waits for a media file request from a media terminal in step S403 and upon receipt of a request streams the requested media file to the requesting media terminal in step S404. Each of the steps will now be described in more detail.

The process begins in step S400 when media storage device 12 is coupled to media hub 10. At this point, media hub 10 and media storage device 12 are configured to send and receive commands and data.

In step S401, media hub 10 constructs a user directory of the media files stored on media storage device 12. To construct the directory, media hub 10 requests a listing from media storage device 12 of the files stored thereon. According to one embodiment, the file listing is reviewed to identify those files having extensions or other identifiers indicating that the file is a media file. Information on files identified as media files is reviewed further to obtain media specific information such as artist, title, genre, duration, etc. The formatting and location of this information for the different digital formats is known to those of skill in the art and will not be described further herein. The user directory is constructed to include the identified media files together with the respective media specific information.

In an alternative embodiment, more than one media storage device 12 may be connected to media hub 10. In this configuration, the user directory is constructed to include the media files stored on each of the connected media storage devices 12. The particular media storage device on which a specific media file is located may be indicated in the user director or, alternatively, the media files may be listed without reference to their specific locations.

In step S402, the constructed user directory is transmitted by media hub 10 to each media terminal 11 coupled to media hub 10. Media hub 10 may transmit the user directory to each media terminal 11 as each media terminal establishes a connection with and is coupled to media hub 10. Alternatively, media hub 10 may transmit the user directory to each media terminal 11 upon receipt of a request for a user directory from the media terminal. This request may be generated automatically by each media terminal 11 upon establishing a connection with media hub 10 or it may be generated in response to user input received at user interface 37 of media terminal 11. After transmitting the constructed user directory, media hub 10 awaits a media file request from a media terminal 11 at step S403.

Upon receiving the user directory from media hub 10, media terminal 11 displays the user directory via user interface 37. In this manner, a user can see what media files are available on media storage device 12 and select one or more of the files for playback. Media terminal 11 may be configured to allow the user to manipulate the display format of the user directory. For example, the user may be able to order the displayed media files according to artist, title, duration, etc. Additionally, media terminal 11 may be configured to allow the user to select one media file at time or to select multiple media files to request from media hub 10.

The request for one or more media files is communicated between media terminal 11 and media hub 10 via the respective wireless interface. Upon receiving the request, media hub 10 streams the requested media file(s) to the requesting media terminal 11 via the respective wireless interface in step S404. Media hub 10 may stream the requested media file(s) directly from the coupled media storage device 12 or, alternatively, media hub 10 may transfer the requested media file(s) from the media storage device 12 to an internal buffer arranged within RAM 21 or data storage device 23 prior to streaming the requested media file(s) to the requesting media terminal 11. The invention is not limited to any particular streaming protocol and may be implemented using any of a number of streaming protocols known to those of skill in the art. Upon receiving the streamed media file from media hub 10, the receiving media terminal 11 decodes the media file, if necessary, using decoder 38, and plays back the media file for the user via user interface 37. Because any decoding is performed at the media terminal rather than the media hub, the media files can be treated as generic data files for purposes of streaming. This simplifies the transfer process between media hub 10 and media terminal 11 and allows error correction and data recovery techniques to be employed that might not be available if the media files were decoded at media hub 10 prior to streaming.

As described above, multiple medial terminals 11 may be wirelessly coupled to media hub 10. Media hub 10 treats the requests from each media terminal 11 separately and independently streams the media file(s) requested by the respective media terminals 11. The number of media terminals 11 that may be coupled to media hub 10, and correspondingly the number of independent streams generated by media hub 10 is not limited within the scope of the invention. Practically speaking, however, this number will be limited by the capacities of the wireless interfaces, the processing capabilities of the processing units, the bandwidth of the media storage device interface, etc. This pull type media file delivery process allows multiple users independent access and playback of media files stored on a single media storage device.

Media storage device 12 has been described above as a storage medium containing one or more media files. In an alternative embodiment, media storage device 12 may act as a portal to live streaming content such as Internet radio stations. Identification information on the available live streams is provided by media storage device 12 to media hub 10 for constructing a user directory. Upon receiving a request for one of the live streams form media terminal 11, media hub 10 channels the live stream to the requesting media terminal 11 via the respective wireless interfaces.

The foregoing description is provided to enable one skilled in the art to practice the various embodiments of the invention described herein. Various modifications to these embodiments will be readily apparent to those skilled in the art, and generic principles defined herein may be applied to other embodiments. Thus, the following claims are not intended to be limited to the embodiments of the invention shown and described herein, but are to be accorded the full scope consistent with the language of the claims. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A media hub, comprising:
a device interface configured to detachably couple said media hub with a media storage device;
a wireless interface configured to wirelessly couple said media hub with up to a plurality of media terminals; and
a processing unit configured to stream one or more media files stored on the media storage device independently to one or more media terminals via said wireless interface in response to a request received from each of the one or more media terminals via said wireless interface.

2. The media hub according to claim 1, wherein said processing unit is further configured to construct a user directory of media files stored on the media storage device and to transmit the user directory to the up to a plurality of media terminals via said wireless interface, wherein the request received from each of the one or more media terminals is based on the user directory.

3. The media hub according to claim 1, wherein the one or more media files comprises audio and/or video data.

4. The media hub according to claim 1, wherein said processing unit is further configured to stream the one or more media files in an encoded format.

5. A multimedia system, comprising:
one or more media terminals; and
a media hub configured to be detachably coupled with a media storage device and to be wirelessly coupled with said one or more media terminals,
wherein said media hub is further configured to wirelessly stream one or more media-files stored on the media storage device independently to said one or more media terminals in response to a request received from each of said one or more media terminals.

6. The multimedia system according to claim 5, wherein said media hub is further configured to construct a user directory of media files stored on the media storage device and to transmit the user directory to said one or more media terminals,
wherein the request received from each of said one or more media terminals is based on the user directory.

7. The multimedia system according to claim 5, wherein the one or more media files comprises audio and/or video data.

8. The multimedia system according to claim 5, wherein said media hub is further configured to stream the one or more media files in an encoded format.

9. The multimedia system according to claim 8, wherein said one or more media terminals are configured to decode the one or more media files streamed by said media hub for user playback.

10. A method for providing access to media files stored on a media storage device, comprising the steps of:
receiving a request at a media hub coupled to the media storage device from each of one or more media terminals for one or more media files stored on the media storage device; and
streaming the one or more media files independently from the media hub to the one or more requesting media terminals,
wherein the request from each of the one or more media terminals is received wirelessly at the media hub from the one or more media terminals and the one or more media files are streamed wirelessly from the media hub to the one or more media terminals.

11. The method according to claim 10, further comprising the steps of:
constructing a user directory of the media files stored on the media storage device; and
transmitting the user directory from the media hub to the one or more media terminals,
wherein the request received from each of the one or more media terminals is based on the user directory.

12. The method according to claim 10, wherein the one or more media files comprises audio and/or video data.

13. The method according to claim 10, wherein the one or more media files are transmitted in an encoded format.

14. A machine-readable medium containing machine-executable code for performing a method for providing access to media files stored on a media storage device, the method comprising the steps of:
receiving a request at a media hub coupled to the media storage device from each of one or more media terminals for one or more media files stored on the media storage device; and
streaming the one or more media files independently from the media hub to the one or more requesting media terminals,
wherein the request from each of the one or more media terminals is received wirelessly at the media hub from the one or more media terminals and the one or more media files are streamed wirelessly from the media hub to the one or more media terminals.

15. The machine-readable medium according to claim 14, wherein the method further comprises the steps of:
constructing a user directory of the media files stored on the media storage device; and
transmitting the user directory from the media hub to the one or more media terminals,
wherein the request received from each of the one or more media terminals is based on the user directory.

16. The machine-readable medium according to claim 14, wherein the one or more media files comprises audio and/or video data.

17. The machine-readable medium according to claim 14, wherein the one or more media files are transmitted in an encoded format.
